(19) United States
(12) Patent Application Publication
(10) Pub. No.: US 2005/0065863 A1
(43) Pub. Date: Mar. 24, 2005

(54) Dynamic cost accounting

(75) Inventors: Edward S. Plumer, Georgetown, TX (US); Robert S. Golightly, Austin, TX (US); Graham Gaylard, Cambridge (NZ); Ralph Bruce Ferguson, Round Rock, TX (US)

Correspondence Address: MEYERTONS, HOOD, KIVLIN, KOWERT & GOETZEL, P.C., P.O. BOX 398, AUSTIN, TX, 78767-0398, US

(73) Assignee: Pavilion Technologies, Inc.

(21) Appl. No.: 10/983,874

(22) Filed: Nov. 8, 2004

Related U.S. Application Data
(63) Continuation of application No. 10/441,936, filed on May 20, 2003.
(60) Provisional application No. 60/382,301, filed on May 22, 2002.
(60) Provisional application No. 60/382,296, filed on May 21, 2002.

(51) Int. Cl. G06F 17/60

(52) U.S. Cl. 705/30

(57) ABSTRACT

A computer-implemented method for performing dynamic cost accounting for an enterprise, wherein the enterprise includes a costing system. The method includes programmatically retrieving input information for the costing system, e.g., from one or more (possibly remote) information sources over a network, dynamically updating the costing system in accordance with the retrieved input information to generate an updated costing system, and the updated costing system calculating one or more outputs which are usable in managing the enterprise. The retrieving and update may occur periodically, e.g., monthly, weekly, per hour, minute, second, millisecond, etc., or on demand. In some embodiments, the enterprise may further include one or more optimizers, wherein the optimizers are provided with the one or more outputs of the costing system, and executed to determine one or more optimal operating parameters for the enterprise. The determined optimal operating parameters are then used to manage or execute enterprise operations.

### CONTINUATION AND PRIORITY DATA

This application is a continuation of U.S. patent application Ser. No. 10/441,936, titled “Dynamic Cost Accounting” filed May 20, 2003, whose inventors are Robert S. Golightly, Edward S. Plumer, Graham Gaylard and Ralph Bruce Ferguson, which claims benefit of priority of U.S. provisional application Ser. No. 60/382,301 titled “Dynamic Cost Accounting” filed May 22, 2002, whose inventors are Robert S. Golightly, Edward S. Plumer, Graham Gaylard and Ralph Bruce Ferguson, and which also claims benefit of priority of U.S. provisional application Ser. No. 60/382,296 titled “Dynamic Cost Accounting” filed May 21, 2002, whose inventors are Robert S. Golightly, Edward S. Plumer and Graham Gaylard which are hereby incorporated by reference in their entirety.

### FIELD OF THE INVENTION

The present invention generally relates to the field of cost accounting. More particularly, the present invention relates to dynamic cost accounting for an enterprise. The use of dynamic cost accounting as part of an optimization process, as well as the use of dynamic cost accounting in planning and forecasting is also described.

### DESCRIPTION OF THE RELATED ART

Businesses, governmental and educational entities, and others have a need for a cost accounting system that is useful in determining the costs of producing a product or service with greater precision and flexibility. The ability to determine the “true” costs of producing a product or service can be useful for many purposes, including budgeting, budget forecasting, production planning, determining and increasing overall profitability, allocating resources, identifying profitable and unprofitable goods or services, finding an economic break-even point, uncovering opportunities for cost improvement, measuring performance, and improving strategic and tactical decision making.

Costs typically have been divided into two broad categories. The first category, direct costs, includes those costs that are directly expended in providing a product or service. Examples of direct costs include, for example, wages paid to production-line workers who effect the form, fit, or function of the product, or those who directly provide a service, and the cost of raw material, inventory, or purchased finished components that become part of the final product or service. The second category, indirect or overhead costs, includes all costs that are indirectly expended in providing a product or service. Examples of indirect costs include, for example, rent, utilities, and costs of equipment maintenance.

Over time, extensive investment has enabled the measurement of the direct costs. Analytical methods and information technology to measure these direct costs are common, however, the overhead costs have always proved to be difficult to attribute to specific processes and products. As the ratio of direct costs to overhead costs has decreased, errors in overhead cost calculations related to processes and products resulting from the use of common cost accounting techniques have increased, and in some cases, the calculations have become so error-prone that the overall cost information provided by companies' information systems has been distorted and made substantially irrelevant.

In traditional costing, overhead costs are assigned to products based on the direct labor and/or direct material content of each part comprising that product. An example of such traditional costing is now described in the context of a manufacturing plant that produces two variations of an automobile engine. If this operation had overhead costs that, if divided by the total direct labor cost, yielded a 5:1 ratio, then a 500 percent overhead allocation or “burden” rate would be multiplied by each engine's direct labor cost to determine the overhead cost. If engine #1 had a direct labor cost of $25, then its overhead cost would be $125; and if engine #2's direct labor cost was $22, then its overhead cost would be $110. Any difference between the total overhead cost and that assigned to products would be captured in price and volume variance accounts. While these calculation methods are straightforward and readily transferable to automation and analysis, they are not likely to be accurate in today's environment. The nature and complexity of that $235 of overhead costs may have nothing to do with how direct labor relates to the two products. In an era when burden rates were 15. percent or less, perhaps this method was reasonable. However, intuitively, one can see that assigning 80 percent of the cost based on how 20 percent is incurred is not logical. As technology and automation have replaced direct labor, overhead cost as a percentage of total cost has increased, thereby reducing the accuracy of the direct labor-based or direct material-based overhead assignment methods. Therefore, organizations relying on standard costing techniques to make decisions regarding the profitability of its products or future investments in new products are substantially at risk for making the wrong decisions.

Thus, traditional costing methods for assigning overhead to product costs often produce distortions that can lead management to make poor decisions. In general, what emerges in traditional costing is an aggregation of product costs in a narrow range. The true differences in cost caused by variations in complexity are simply not captured or measured. Since traditional costing methods assign costs on a volume basis, products that are of either low volume and low complexity or high volume and high complexity are perhaps not heavily distorted by these methods. However, since traditional methods cannot distinguish complexity, low-volume, high-complexity products are typically under-costed, while high-volume, low-complexity products are typically over-costed. Since much of today's business environment is characterized by demanding customers seeking tailored products and services, a costing system that can accommodate these types of products is critical to success.

Over the last several years, in an effort to determine a more accurate method of determining “true” costs, many have turned to new cost accounting methods such as activity-based cost (“ABC”) accounting. ABC accounting is a method of cost assignment that evaluates first how resources are consumed by the activities performed in the process of producing the product or service, and second how the company's products, services, customers, channels and brands consume these activities and resources. FIG. 1 illustrates a traditional prior art approach to ABC accounting. Resources 108 are the cost of tangible or intangible items consumed, and may include the cost of people and facilities as captured in traditional financial systems such as general ledger accounts 110, and may also include the cost of materials 106. Activities 104 are actions taken, such as the tasks people perform and the purposes facilities serve. ABC accounting uses activity data to assign the costs of these activities and resources to end cost objects such as products or services 102A and 102B, which may be referred to collectively or generically as products or services 102, based on relevant drivers 112. A driver 112 may define the quantity of a resource consumed by an activity, or may define the quantity of an activity consumed by another activity, or the quantity of an activity consumed by the product or service. For example, the driver might be sales or production volumes for some types of costs; but, more importantly, drivers could also be statistics such as number of setups, number of material moves, part existence, number of engineering changes, rework hours, number of customer calls, number of invoices, or number of purchase orders. This two-stage costing method, while dependent on identifying and quantifying data that is diverse and sometimes difficult to obtain, provides a much more meaningful depiction of the “true” costs in an enterprise.

ABC accounting provides a mechanism to capture indirect or overhead costs associated with a product or service. However, while it offers great advantages over traditional product costing methods, it too suffers from shortcomings. One shortcoming is that the values used in ABC accounting for the drivers, as well as the set of activities and resources and the interrelationship among the activities and resources, are static and updated infrequently, although in reality the activities and resources may change over time. Stated another way, ABC accounting techniques assume that the nature and quantity of activities and/or resources consumed by an activity is constant, even though in reality the nature and quantity consumed may change over time. While in some instances the variations in these activities, resources and drivers are not significant enough to track, there are many instances where the differences can amount to significant expense.

Another shortcoming with product costing and ABC costing is that neither captures a class of costs associated with enterprise processes referred to as “state costs”. For example, with respect to operation of an automobile, the variable operating costs of the automobile consist of fuel, maintenance and a few other categories. The fuel costs can determined by the way the car is being used—that is by its state. In a simple case, the fuel costs can be computed by determining if the car is being driven in town or on the highway. The value for expected miles-per-gallon, and thus fuel costs, may change based on the “state” the automobile is in; that is, whether it is being driven in town or on the highway. The same concept applies to most operational processes. The cost of operating these processes can vary with a number of factors, including state parameters such as ambient conditions, equipment condition, raw material properties and others. Also, it becomes increasingly difficult to determine state costs as the number of factors increases, and as the interrelationship between the factors and the drivers become more complex.

Therefore, improved systems and methods for cost accounting are desired.

### SUMMARY OF THE INVENTION

Various embodiments of a system and method for performing dynamic cost accounting for an enterprise are disclosed. The method comprises programmatically retrieving input information for a costing system within the enterprise, dynamically updating the costing system in accordance with the retrieved input information to generate an updated costing system, and the updated costing system calculating one or more outputs, wherein the one or more outputs are usable in managing the enterprise.

The retrieved input information may be from one or more (possibly remote) information sources over a network, while the costing system may include one or more models comprising one or more cost pools connected by linkages, and one or more parameters. As the costing system is updated, the cost pools, linkages and/or parameters in said models may be modified based on the new input information.

New information may be retrieved and models updated periodically, with the retrieval period varying in range from a month to a millisecond. Alternatively, input sources may be monitored and input retrieved if a change in an input element meets one or more criteria. Input elements may include the cost of resources, cost of capital, sequence and mix specifications, geographic location, ambient conditions, customer information, environmental information, and executive instructions, or parameters of a business process. Input elements may be time dependent, or may be outputs of various predictive models.

In further embodiments, the enterprise may further comprise one or more optimizers, which are provided with the one or more outputs of the costing system and which are executed to determine one or more optimal operating parameters for the enterprise. Alternatively, the optimizers may provide one or more financial parameters for the enterprise (such as a key performance indicator), which may further be used in conjunction with the costing system to evaluate a plurality of plans and select an optimal plan for the enterprise. The plan may then be enacted by the enterprise.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a traditional cost model used in an activity-based costing;

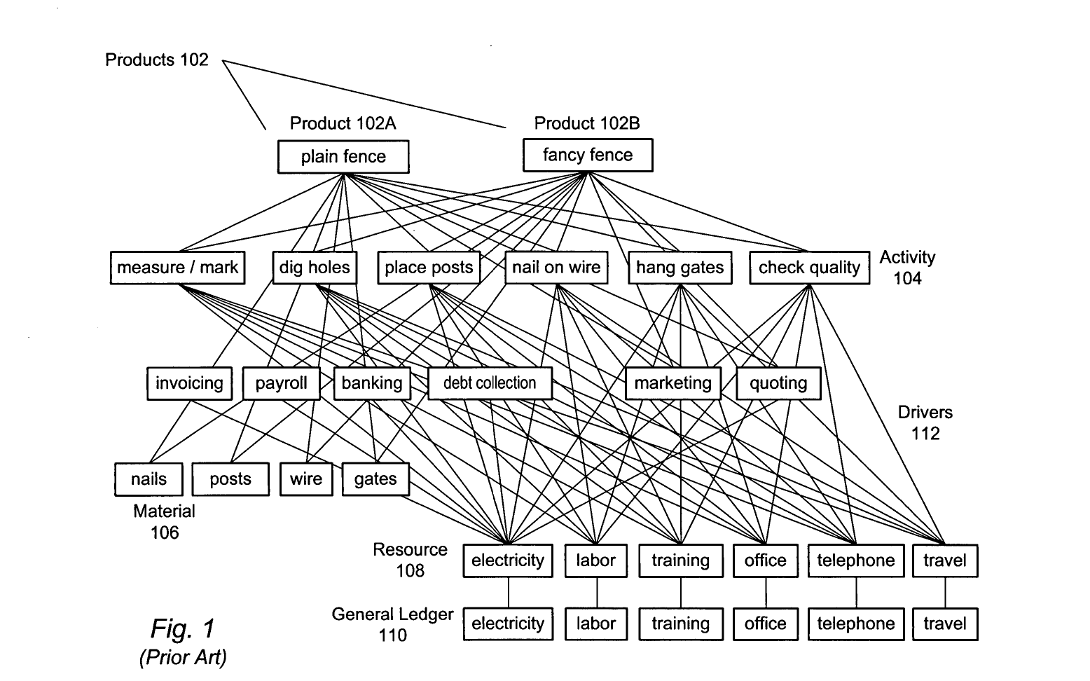

FIG. 2A illustrates a simplified and exemplary view of a dynamic cost accounting system, according to one embodiment of the present invention;

FIG. 2B is a block diagram of a dynamic cost accounting system in an enterprise, according to one embodiment;

FIG. 3 illustrates a cost model comprising of a network of cost pools, according one embodiment;

FIG. 4A illustrates a block diagram of a cost pool, according one embodiment;

FIG. 4B illustrates the manner in which consumption is allocated, according one embodiment;

FIG. 4C illustrates the manner in which local costs are calculated, according one embodiment;

FIG. 4D illustrates the manner in which costs are aggregated and propagated, according one embodiment;

FIG. 5 illustrates the manner in which a dynamic cost accounting system may by used to manage an enterprise, according one embodiment;

FIG. 6 illustrates a dynamic cost accounting system for an enterprise linked with an operation system of the enterprise, according one embodiment;

FIG. 7 illustrates a response surface of a model for a production process, according one embodiment;

FIG. 8 illustrates the use of the cost model within a production mix planner to determine the optimal operating point for the production process, according one embodiment;

FIG. 9 illustrates the manner in which a dynamic cost accounting system may be used with an optimizer, according one embodiment;

FIG. 10A illustrates the manner in which a dynamic cost accounting system may be used in strategic or tactical planning for an enterprise, according one embodiment;

FIG. 10B illustrates the various elements that may be included in scenarios and result-sets, according one embodiment;

FIG. 10C illustrates scenario structure, according one embodiment;

FIG. 10D illustrates the process of generating and evaluating different planning scenarios, according to one embodiment;

FIG. 10E illustrates the manner in which a dynamic cost accounting system may be used to generate real-time performance monitoring information; and

FIG. 11 illustrates a dynamic cost accounting system for an enterprise linked with the business systems of the enterprise, according one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE EMBODIMENTS

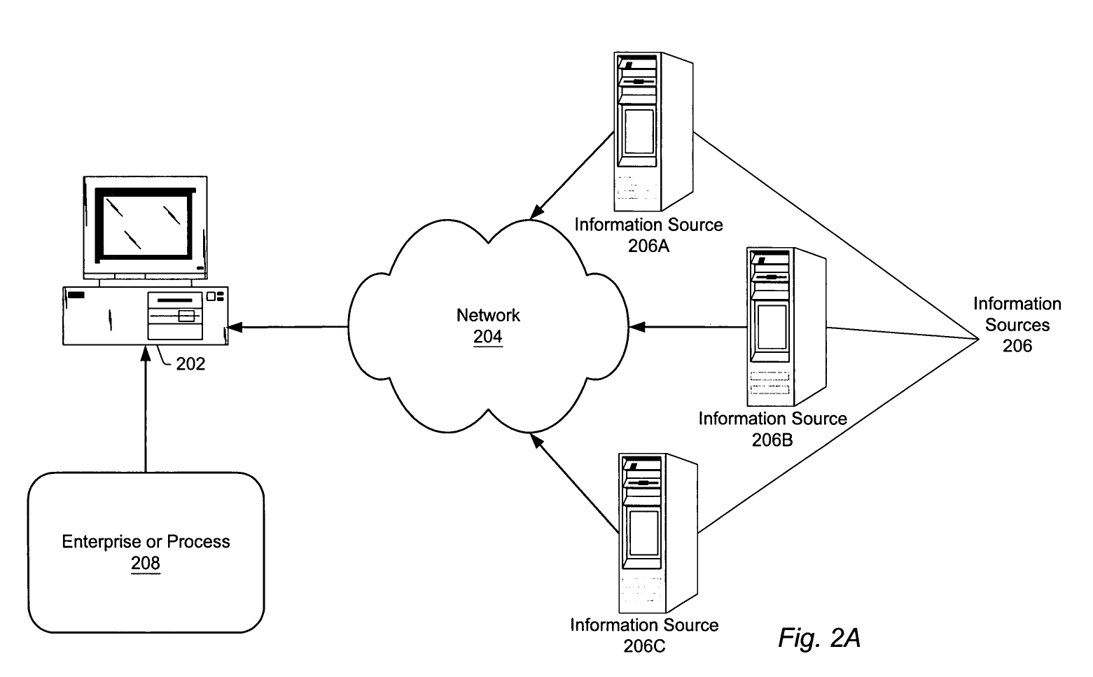

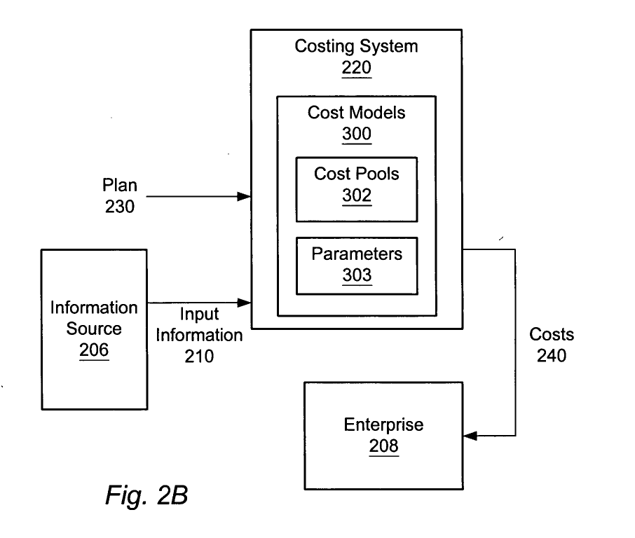

FIG. 2A—Exemplary System With Multiple Remote Information Sources

FIG. 2A illustrates a simplified and exemplary view of one embodiment of a system according to the present invention. As shown, the system may include one or more computer systems 202 coupled to a plurality of remote information sources 206A, 206B, and 206C, which may be referred to collectively or generically as information or data source(s) 206, over a network 204, e.g., a Local Area Network (LAN), or a Wide Area Network (WAN), such as the Internet. Although the information sources shown in FIG. 2A are shown as server computers, it is noted that in various embodiments, the information sources may comprise other types of sources, including, for example, sensors, live data-feeds, such as stock tickers, instruments, etc. The computer system 202 may represent any of various types of computer systems or networks of computer systems which execute software program(s) according to various embodiments of the invention. The software program(s) may perform various aspects of dynamic cost accounting for a process, system or enterprise 208.

The process, system or enterprise 208 may be one that is being modeled, optimized and/or controlled, and element 208 is referred to generally herein as an enterprise for convenience. Examples of an enterprise 208 include a manufacturing business, a chemical process, financial services, a supply chain process, an e-commerce enterprise, such as a business-to-consumer e-commerce enterprise or a business-to-business e-commerce enterprise, a business-to-business e-commerce marketplace, etc. In the following discussion, the enterprise 208 is considered to be a manufacturing or automation enterprise. However, this is not intended to limit the invention, it being noted that the systems and methods described herein may be readily used in performing dynamic cost accounting of any type of process, system or enterprise.

For example, with respect to a business-to-business e-commerce marketplace process, the cost accounting system(s) may execute software which performs cost accounting for various business transactions held in an electronic forum, which may also be modeled, optimized and/or controlled.

Various embodiments of the present invention include techniques for improving enterprise operations, such as manufacturing operations in one or more plants, e-commerce operations, business-to-business e-commerce systems, financial systems, etc. These techniques are described below with respect to manufacturing processes, but may be readily applied to any of various enterprise systems, such as those mentioned above, among others.

One or more software programs that perform modeling, prediction, optimization and/or control of the process 208 may be included in the computer system 202, or alternatively, in an information source 206, e.g., one or more of information sources 206A, 206B, and 206C. Thus, the system may provide an environment for a cost accounting process of programmatically retrieving information relevant to the resources or activities used in a system, process or enterprise, and updating a costing system for the system, process or enterprise with such information. The system may further provide an environment for programmatically retrieving information relating to state costs from the system, process or enterprise. Additionally, the system and method may further provide an environment for applying the results of the costing system to the operation and/or optimization of the process, system or enterprise.

The one or more computer systems 202 preferably include a memory medium on which computer programs according to the present invention are stored. The term “memory medium” is intended to include various types of memory or storage, including an installation medium, e.g., a CD-ROM, or floppy disks, a computer system memory or random access memory such as DRAM, SRAM, EDO RAM, Rambus RAM, etc., or a non-volatile memory such as a magnetic medium, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution.

Also, the computer system(s) 202 may take various forms, including a personal computer system, mainframe computer system, workstation, network appliance, Internet appliance or other device. In general, the term “computer system” can be broadly defined to encompass any device having a processor which executes instructions from a memory medium.

The memory medium preferably stores one or more software programs for performing various aspects of dynamic cost accounting. In one embodiment, the software program(s) may be implemented using component-based techniques and/or object-oriented techniques. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

FIG. 2B—A Dynamic Cost Accounting System for an Enterprise

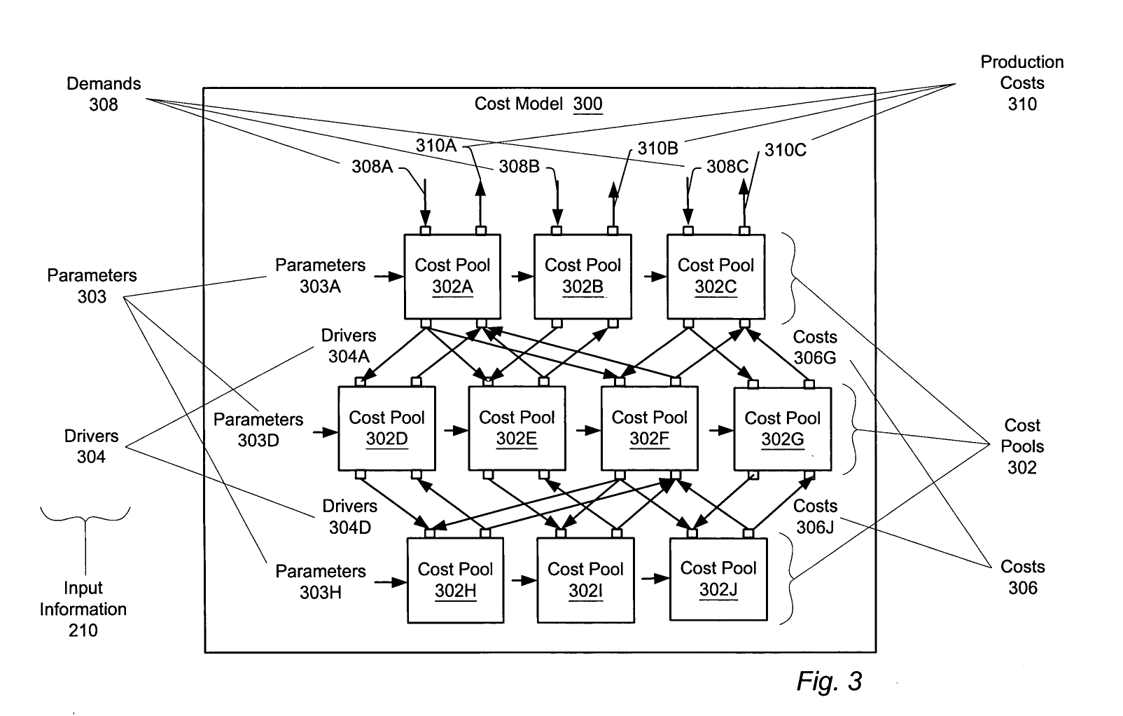

FIG. 2B illustrates a dynamic cost accounting system used in an enterprise 208 according to one embodiment of the invention. The dynamic cost accounting system may include a costing system 220 that calculates the costs 240 associated with a given plan 230. The calculated costs 240 may be used to manage the enterprise 208. The costing system 220 may be updated in accordance with changes in input information 210 received from one or more information sources 206. In one embodiment of the invention, the costing system 220 may include one or more cost models 300. The cost models may be interrelated in accordance with a structure or topology. In one embodiment, one or more cost models 300 may include one or more parameters 303 and cost pools 302, and the cost pools may be interconnected by linkages. The cost pools 302 may be networked together according to a structure or topology. The one or more parameters 303, the structure and/or topology of the cost model 300, the cost pools 302 and/or the linkages between the cost pools may be updated in accordance with changes in the received input information 210. In one embodiment, the updating of the cost model 300 may include adding and/or deleting cost pools 302 and linkages between the cost pools. The cost model 300, cost pools 302, and parameters 303 are described in more detail with reference to FIG. 3 below.

FIG. 3—Cost Model

FIG. 3 illustrates a cost model 300 used in a dynamic cost accounting system to calculate total production costs 310A, 310B, and 310C, referred to collectively or generically as production costs 310, for a given set of demands 308A, 308B, and 308C, referred to collectively or generically as demands 308 and parameters, such as 303A, 303D, and 303H, referred to collectively or generically as parameters 303, according to one embodiment. The demands 308 may be a plan for producing one or more products in an enterprise 208, e.g., a set of production orders. The demands 308 may be an actual production plan, or may be a hypothetical production plan used for the purpose of logistic, tactical, or strategic forecasting or planning, among other uses. The demands 308 may change over time. The cost model 300 may calculate the production costs 310 taking into account changes in the demands 308. The production costs 310 may be broken down into categories of costs.

The embodiment of the present invention illustrated in FIG. 3 represents a dynamic cost accounting system based on activity based cost accounting. However, this is not intended to limit the invention, it being noted that the systems and methods described herein may be readily used in other accounting methodologies. The calculated costs depend upon one or more cost drivers, referred to collectively or generically as “drivers” 304, where a driver represents the level of demand placed on the system for the performance of a task or activity, the consumption of a set of materials, or the allotment of a set of resources, and thus may include activity drivers, resource drivers, etc. As used herein, the term “activity” refers to the performance of one or more tasks (including the task of consuming a resource) for which a cost may be accrued.

As FIG. 3 shows, the cost model 300 includes one or more cost pools 302, here represented by example cost pools 302A, 302B, 302C, 302D, 302E, 302F, 302G, 302H, 302I, and 302J, and referred to collectively or generically as cost pool(s) 302, networked in a manner that allows the propagation of drivers 304 and costs 306 among the cost pools 302. Each cost pool 302 may be associated with a particular account, class of accounts, resource, class of resources, activity, class of activities, cost object or class of cost objects. Cost pools may represent one or more physical products or activities or a usage of one or more resources. Examples of activities associated with a cost pool include stirring a bread mixture, the consumption of electricity, or paying secretaries, among others. The cost pools may be networked together in accordance with a structure or topology that represents the interrelationship of the various resources and activities associated with the cost pools. The consumption of a particular activity associated with one cost pool may require or “drive” a certain level of sub-activities associated with one or more other cost pools. These sub-activities, in turn, may drive a certain level of other sub-activities associated with one or more other cost pools. The level of activity requested by one cost pool from another is represented by the drivers 304, for example, drivers 304A and 304D, requested and received from cost pools 302A and 302D, respectively. Thus, as FIG. 3 shows, each cost pool 302 may receive respective parameters 303 and drivers 304 (or demands 308), and generate respective costs 306 (or production costs 310).

Each cost pool may generate the costs 306 associated with the level of activity being driven by one or more other cost pools 302, such as for example, costs 306G and 306J, generated by cost pools 302G and 302J, respectively. These costs 306 may be propagated back to the cost pools that generated the requests or drivers, as further described below. The costs 306 may be aggregated throughout the network of cost pools 302 to generate the total production costs 310. Thus, the cost pools 302 may be linked together by linkages such as the drivers 304 and costs 306.

The cost pools 302 may receive parameters 303 that are used in the calculation of the costs 306 associated with the cost pool activity or set of activities. The parameters may also be used to generate consumption levels that may be passed on to other cost pools as drivers 304, e.g., activity drivers, resource drivers, etc. Examples of parameters 303 include, for example, the number of full-time operators on a production line, the quantity of raw material on hand, and the uptime of certain manufacturing equipment, among others. The parameters 303 may include weighting coefficients or models. One or more of the parameters 303, the cost pools 302, the structure and/or topology of the cost model 300, and the linkages between the cost pools may be dynamically updated in accordance with retrieved input information 210 from an information source 206. The retrieval of the input information 210 by the costing system 220 may be continuous (e.g., a live data feed), or may be event based or time based. In one embodiment of the invention, the updating of the cost model 300 in accordance with the retrieved input information 210 may be event based or time based. Examples of time based updating may include, for example, updating monthly, weekly or daily. Examples of event based updating may include, for example, updating based on one or more conditions internal or external to the costing system, such as the condition of the retrieved input information 210, a pattern in the input information 210, or an executive command, among others. In another embodiment of the invention, the cost model 300 is updated when the value of the retrieved input information 210 exceeds a threshold. The information source 206 may include one or more operations systems within the enterprise 208, which may include production control systems, for example. Using the parameters 303 received from information sources 206, or from operations systems such as a production control system as further described below, a dynamic costing system can switch driver models in and out of the cost model 300.

Total production cost 310 estimates may be generated by running all of the cost pools in the cost model and aggregating the results. As the parameters 303 are programmatically updated in accordance with the input information 210 retrieved from information sources 206, the cost model 300 may be updated, generating production costs 310 that reflect the changes in the parameters 303.

Thus, dynamic cost accounting may provide dynamic cost information for an activity or set of activities.

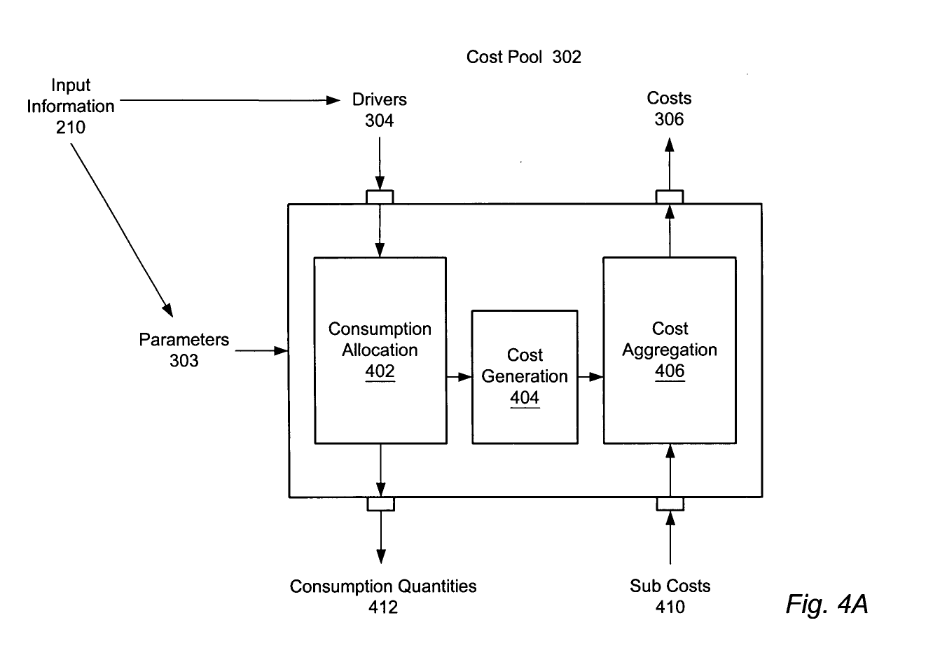

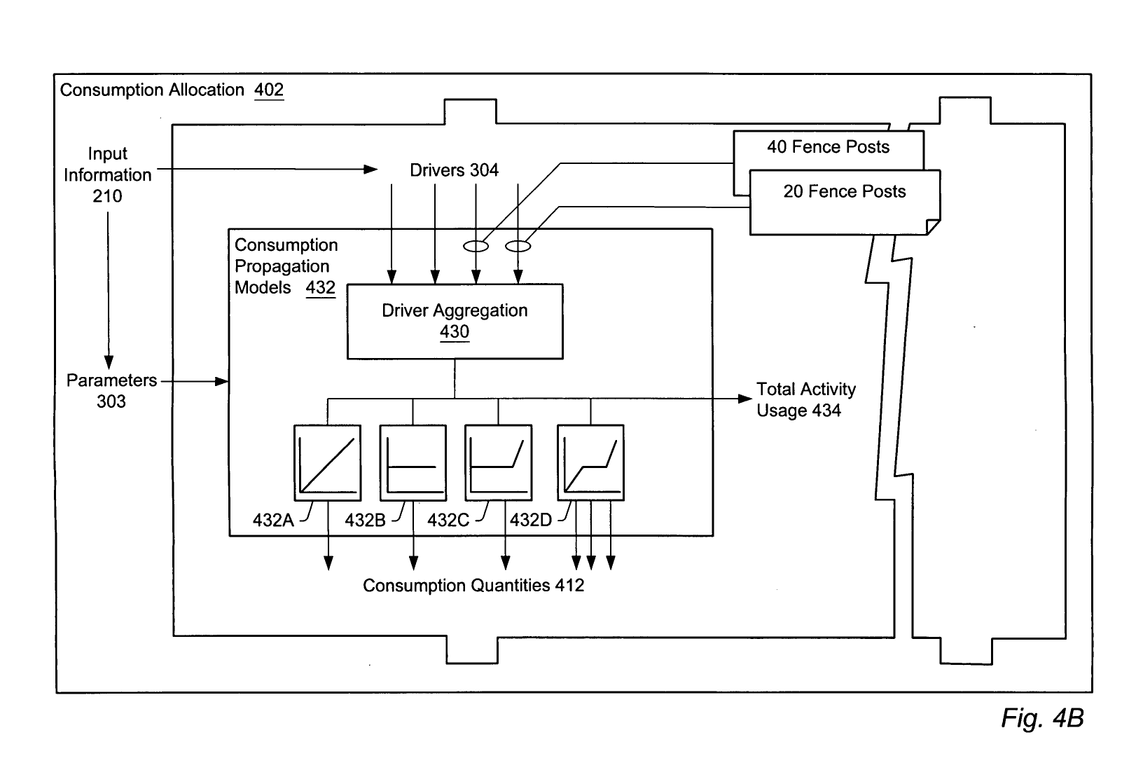

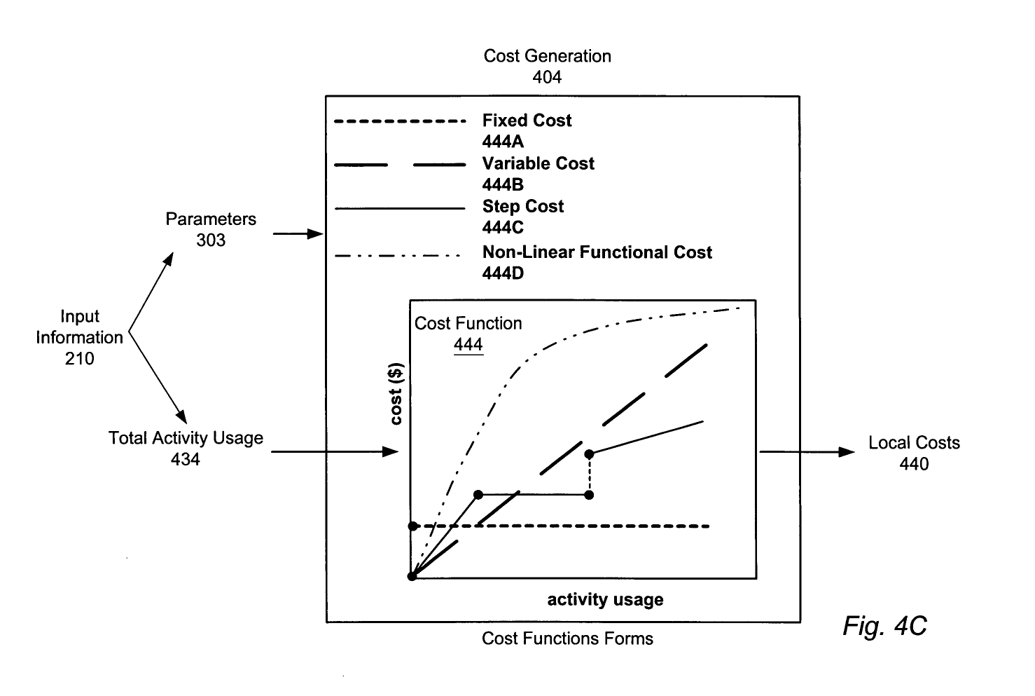

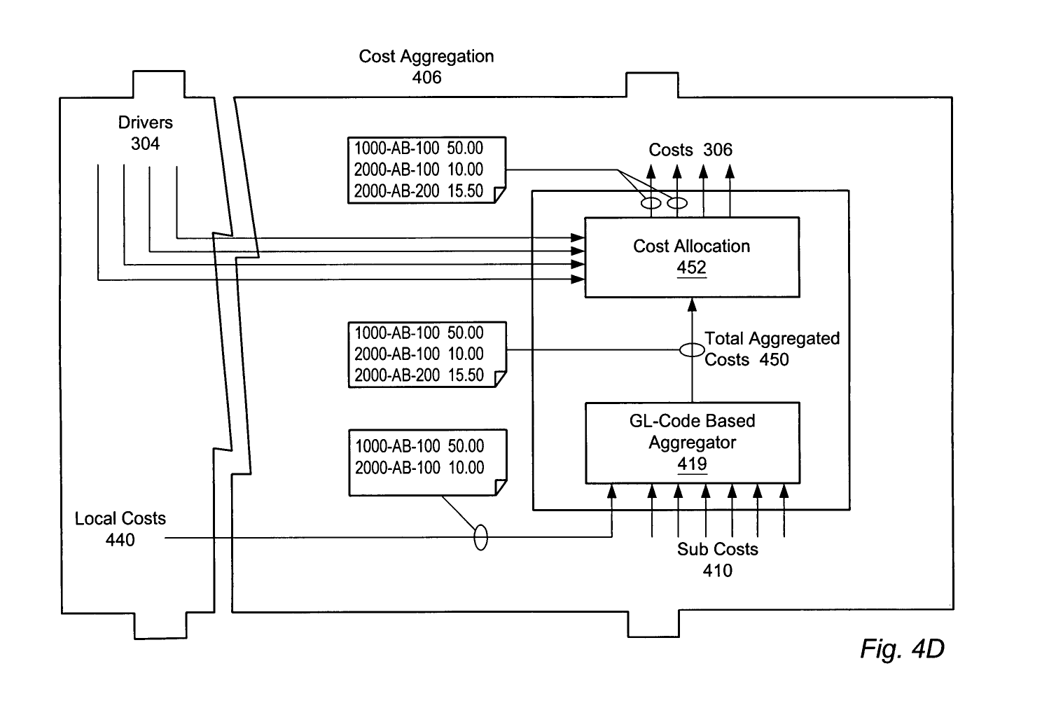

FIG. 4A—Cost Pool

FIG. 4A illustrates functions performed by a cost pool through the use of a block diagram, according one embodiment. As described above, the cost pool 302 may receive one or more drivers 304, e.g., activity drivers, resource drivers, etc., as shown in FIG. 4A. These drivers 304 may include consumption quantities 412 received from other cost pools, or demands 308 that are input to the cost model 300, and/or demands provided by sources external to the cost model. As noted above, the term “driver” may refer to activity drivers, resource drivers, cost drivers, and/or any other type of driver used by the system to perform dynamic cost accounting.

The cost pool 302 may calculate costs 306 that may then be propagated back as subcosts 410 to the other cost pools that generated the drivers to the cost pool 302. Said another way, a first cost pool 302A may request a certain level of activity from a second cost pool 302B by providing consumption quantities 412, that are received as drivers by the second cost pool 302B. The first cost pool 302A, and may then receive from the second cost pool 302B, costs associated with the requested level of activity, i.e., the drivers 304, e.g., activity drivers. The function performed by the cost pools 302 may be represented by the blocks shown as consumption allocation 402, cost generation 404, and cost aggregation 406, as further described below.

FIG. 4B—Consumption Allocation

FIG. 4B illustrates the function of consumption allocation 402 within a cost pool 302, according to one embodiment. As mentioned above, the cost pool 302 may receive the drivers 304, e.g., activity drivers, from other cost pools requesting a certain level of the activity or set of activities associated with the cost pool 302. In the example shown in FIG. 4B, the cost pool 302 is associated with the activity of painting fence posts. One of the other cost pools may request that forty fence posts be painted. Another of the other cost pools may request that twenty fence posts be painted. All drivers 304, e.g., activity drivers, received by the cost pool 302 may be aggregated 430 to determine the total activity usage 434 for the cost pool 302. The total activity usage 434 may then be used by the cost generation 404 function, as described below.

The cost pool may determine the required consumption quantities 412 of subactivities or resources associated with other cost pools. One or more parameters 303 may characterize how the activity or set of activities associated with the cost pool is broken down into one or more subactivities or resources, or both. As described below, the parameters 303 may be modified based on retrieved input information 210 from an operations system, such as a production control system. The parameters 303 may represent a local condition of the production process or operation, or other information relevant to other assumptions used in breaking down an activity into subactivities.

The total activity usage 434 may be used to determine required quantities of the subactivities or resources, shown in FIG. 4B as consumption quantities 412. The consumption quantities 412 provided from one cost pool are received as drivers 304 by the other cost pools. The consumption quantities 412 may be determined by consumption propagation models 432 that represent the consumption quantity 412 for a subactivity or resource as a function of total activity usage 434. The consumption propagation models 432 represent knowledge or information about how a process or activity within the enterprise behaves. As seen in FIG. 4B, in one embodiment, a consumption propagation model 432A for an activity or resource may specify that the consumption quantity vary linearly with total activity usage. Other consumption propagation models may specify a fixed consumption quantity 432B, a consumption quantity that is fixed for a certain range of total activity usage, but that varies linearly otherwise 432C, or more non linear functions, such as that shown in 432D. The consumption propagation model may be updated by one or more parameters 303. Furthermore, the consumption propagation model may be replaced by another consumption propagation model received as a parameter 303. Consumption propagation models may be received from operations systems within the enterprise 208, such as a production control system, as further described below.

Thus, the consumption quantities 412 calculated by a cost pool may be updated as the parameters 303 are updated in accordance with changes or updates received from information sources 206 which may include, for example, operations systems, such as a production control system, within the enterprise 208.

FIG. 4C—Cost Generation

FIG. 4C illustrates the cost generation function 404, which may operate to determine local costs 440 for a cost pool 302, according to one embodiment. As FIG. 4C shows, the cost generation function 404 may include cost function 444, which may determine the local costs 440 based on the level of total activity usage 434 and the local conditions within an enterprise. The cost generation function 404 may receive the total activity usage 434 for the cost pool, as well as one or more parameters 303. In one embodiment, the parameters 303 include weighting coefficients for the cost function 444, or the cost function 444 itself. The parameters 303 may also include the local conditions within the enterprise, as well as any other information used to calculate local costs 440. The local costs 440 in a cost pool are the costs of the one or more activities associated with that cost pool, and do not take into account the costs of any subactivities or resources consumed by such activities. The cost function 444 may comprise any of a variety of functional forms, including for example, fixed cost 444A, variable cost, 444B, step cost 444C or non-linear functional cost 444D, among others. In addition, the cost function 444 may be a model, and in one embodiment, may be derived from a model used in an operations system, such as a production control system.

Thus, the local costs 440 calculated by a cost pool may be updated as the parameters 303 are updated in accordance with changes or updates received from information sources 206, e.g., from external sources or internal sources, such as from operations systems within the enterprise, such as a production control system.

FIG. 4D—Cost Aggregation

FIG. 4D illustrates the manner in which local costs 440 are aggregated with subcosts 410 received from other cost pools to calculate the total aggregated costs 450 of the one or more activities associated with the cost pool 302, according to one embodiment. As FIG. 4D shows, in this embodiment an aggregator 419 aggregates subcosts 410 with local costs 440 based upon general ledger code accounts, resulting in total aggregated costs 450. In another embodiment, the aggregator 419 may aggregate subcosts 410 and local costs 440 based upon groups of general ledger code accounts. By including the subcosts, the aggregated costs 450 take into account downstream costs of the one or more subactivities and resources driven by the one or more activities associated with the cost pool 302. Aggregation based on general ledger code accounts may allow for the computation of total aggregated costs 450 to be broken-down into any number of general ledger code account categories as deemed appropriate for the specific application. The total aggregated costs 450 may then be allocated amongst the cost pools 302 from which consumption quantities 412 were requested, e.g., by a cost allocation process 452, as shown. In the embodiment shown in FIG. 4D, the total aggregated costs 450 are allocated amongst the other cost pools in proportion to the levels of activity requested, that is, the drivers 304, e.g., activity drivers, etc., received from the other cost pools.

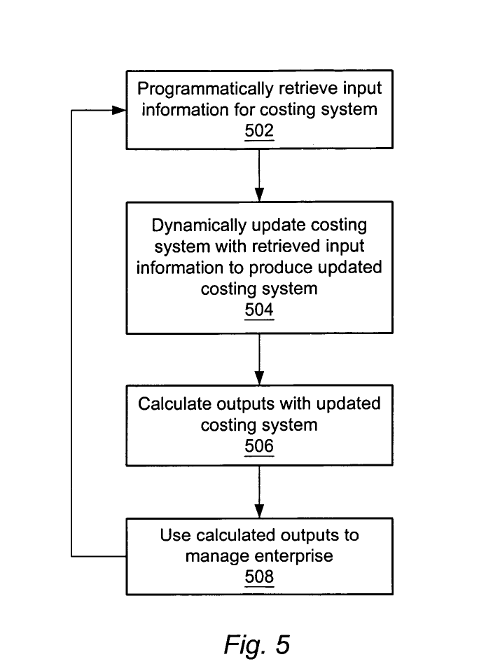

FIG. 5—Method for Performing Dynamic Cost Accounting

FIG. 5 is a flowchart of one embodiment of a method for performing dynamic cost accounting for an enterprise. It is noted that in various embodiments, some of the steps shown may be performed in a different order than shown, or may be omitted. Additional steps may also be performed.

As FIG. 5 shows, in 502, the costing system 220 of the enterprise 208 may programmatically retrieve input information 210 from one or more information sources 206, as described above.

Then, in 504, the costing system 220 may be dynamically updated with the retrieved input information 210, thereby producing an updated costing system. In a preferred embodiment, the costing system 220 may be dynamically updated automatically in response to said programmatic retrieval of the input information 210. For example, in one embodiment, the information sources may be monitored, and the input information 210 retrieved if a change in the input information 210, i.e., a change in the value of a parameter, exceeds a threshold. The costing system 220 may then be updated with the retrieved input information 210. In various embodiments, updating the costing system may include updating parameters or coefficients of one or more cost models included in the costing system, modifying one or more of the cost models, and/or adding, removing, or replacing one or more of the cost models.

In 506, the updated costing system may calculate one or more outputs. For example, the updated costing system may calculate updated costing information related to operations of the enterprise 208. More detailed descriptions of costing system operations are described below.

Finally, in 508, the calculated outputs may be used to manage the enterprise 208. For example, other enterprise processes may receive updated cost information from the costing system, and may use the cost information for strategic planning, product mix optimization, scheduling applications, process optimization, unit optimization, budgeting applications, trading applications, and performance management, among other uses.

As markets have evolved and more products approach commodity status, the cost of each transaction with a given customer can be better evaluated and managed using a dynamic cost accounting system. Further details of the use of the dynamically updated costing system are provided below.

As more fully described below, a dynamic cost accounting system for an enterprise may be linked with one or more systems within the enterprise, including operations systems such as a production control system, and business systems such as production planners and performance measurement systems.

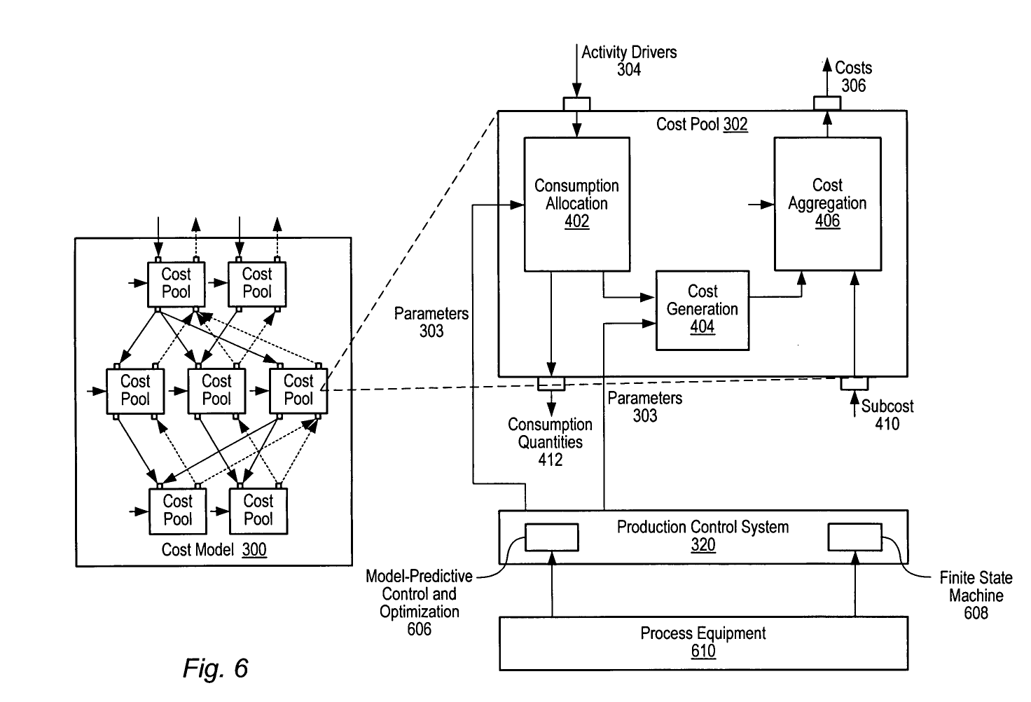

FIG. 6—Dynamic Cost Accounting System Linked With Operations System

FIG. 6 illustrates a dynamic cost accounting system linked with an operations system of an enterprise 208 according to one embodiment of the invention. In one embodiment, the operations system may be a production control system 320 that may include one or more process models. The process models may represent knowledge or information about how a process or activity within the enterprise behaves. Examples of process models are shown in FIG. 6 as a model-predictive control and optimization system 606 and a finite state machine 608. Each process model, in turn, may interface with the actual process 610 within the enterprise 208. The dynamic cost accounting system may programmatically retrieve as parameters 303 updated information from the process models 606 and/or 608 relating to the current processing conditions and operating plan of the activities and processes of the enterprise, and update the costing system 220 in accordance with such updated information. The cost model 300 may then be dynamically updated to take into account changes in current conditions in the enterprise and how such changes affect resource consumption. Thus, a dynamic cost accounting system may use information received from the production control system 320 to calculate the state costs of the process.

The costing system 220 may estimate resource values, drivers and costs in the context of the operating plan used by the production control system 320 and current conditions. Variance in resource values and drivers used by the cost model 300 may be derived from the process models 606 and/or 608 used to control the process 610. Because the process models 606 and/or 608 are being used by the production control system 320 to control the process 610, the process models 606 and/or 608 may also be used by the cost model 300 to more accurately assess the costs associated with the process 610. As the elements of the operating plan change, the costs may be re-estimated for the local conditions represented in the operating plan. Additionally, a greater degree of consistency throughout the enterprise may be achieved in that all systems and processes that require cost information can access a common set of dynamic activity based models.

Thus, by linking the costing system 220 with the production control system 610, the costing system may receive detailed information relating to the production processes and/or activities being performed and to the local conditions that cause variance in costs. As an example, the energy used to produce a unit of final product may vary with atmospheric conditions. In the colder months, more energy is required for the same unit of output. The variance of energy consumption with atmospheric conditions may be represented in a consumption propagation model 432. The cost model 300 may also be dynamically updated with parameters 303 reflecting actual conditions such as atmospheric conditions and the price of energy. Thus, the cost model 300 may be capable of more accurately determining the cost of producing the final product, taking into account the atmospheric conditions and price of energy changes, and the effects of such changes on the process 610.

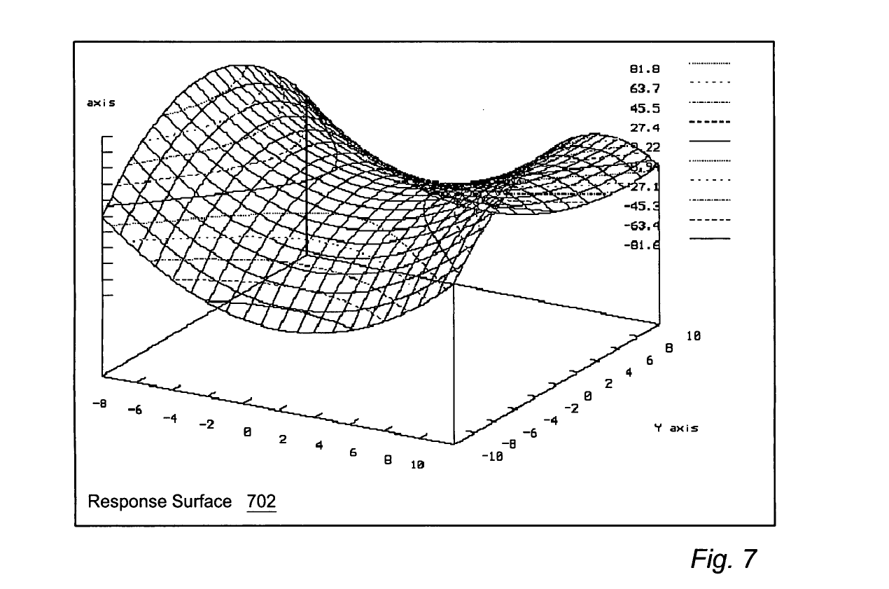

FIG. 7—Response Surface

There are number of different technologies used to implement production control systems 320 for processes such as the manufacturing process 610 shown in FIG. 6. One such technology is Model Predictive Control (MPC). MPC uses multi-dimensional response-surface models to determine how a process will behave at a given operating point in state-space and dynamic models to describe how it will respond to process disturbances.

FIG. 7 illustrates a possible response surface 702 in a model that represents how a process behaves according to one embodiment of the invention. Response surface models can be used in MPC systems to dynamically determine how resource consumption will change for a given set of processing conditions. The use of response-surface and dynamic models, as used in MPC (model predictive control), may offer significant advantages in its ability to predict how a process will react to disturbances. Although the example response surface shown has two dependent variables (x and y), response surfaces may have any number of dependent variables, each representing a particular parameter related to the process.

Dynamic activity based accounting may further leverage the advantages of response-surface and dynamic models by determining how costs will be affected by those disturbances. Using this technique, significant variations in cost that occur as a function of how the plant is operated may be identified. The mix of products and their respective output volumes, along with ambient conditions and other factors, create dynamics in the value of Cost of Goods Sold (COGS). By including key status information such as current total output etc, dynamic activity based accounting can provide a more accurate estimate of COGS for any given situation. In one embodiment, the production or process model used to provide the driver dynamics may be determined by or with a series of state conditions for the process.

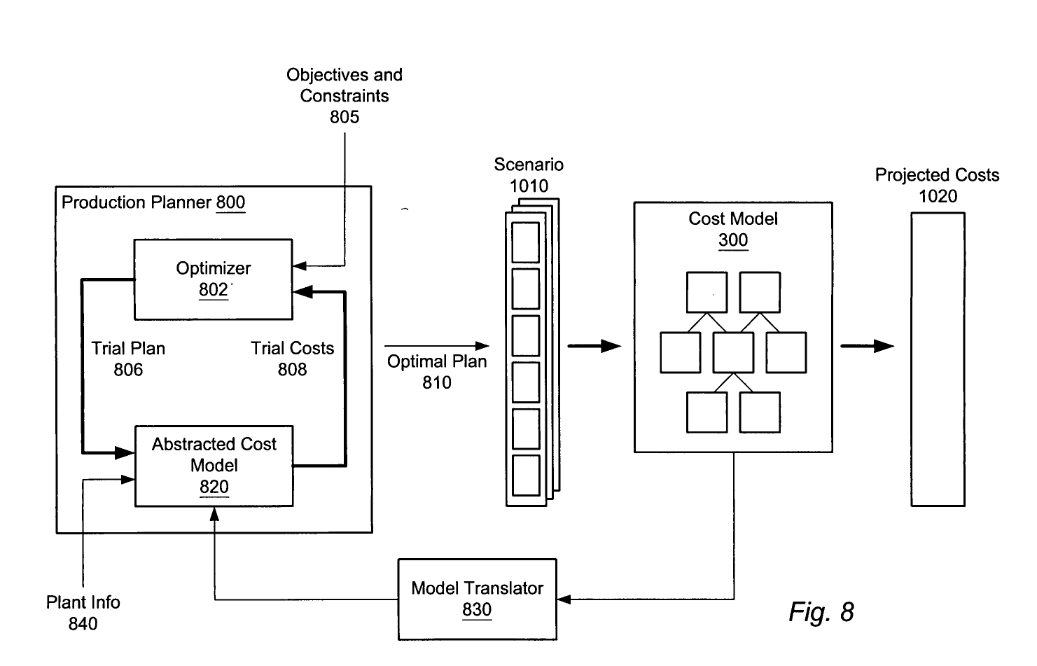

FIG. 8—Determining an Optimal Production Plan

There are advantages to be gained by using the dynamically updated cost information from the cost model in one or more planning systems within the enterprise. FIG. 8 illustrates the process of using a dynamic cost accounting system to generate and evaluate a production plan based on optimization. As before, the technique uses a cost model 300 capable of computing the costs associated with a particular production plan 810, taking into account plant information 840. This model may be provided as input to a production planner 800 which may use the model to generate an optimal (or substantially optimal) plan 810, which may be used by or in conjunction with a scenario 1010, described in detail below. In one embodiment, a model translator 830 may be used to convert the cost model 300 into a simpler abstracted form 820 appropriate for use within the chosen optimization formulation. This translation may be based on an estimate of the production plan. In many cases, this abstracted model may be represented as a constrained linear problem (LP). In another embodiment, the full cost model 300 may be used within the production planner 800.

An optimizer 802, which may be considered to be a type of search strategy, may be used to generate a series of trial production plans 806. The trial costs 808 associated with these trial plans may be computed using the abstracted cost model 820. In conjunction with a set of objectives and constraints 805, these costs may be used to evaluate the fitness of each of these trial plans. The optimization process is completed when a trial plan that best meets the fitness criteria is found. This plan is then selected as the optimal output plan 810 of the production planner 800, which, as noted above, may be used by or in conjunction with a scenario 1010, described below.

This optimal production plan 810 may then be passed to a full cost model 300 in order to generate the actual predicted costs 1020. If desired, the process can be repeated with a new abstracted model generated based on the new estimate of the production plan.

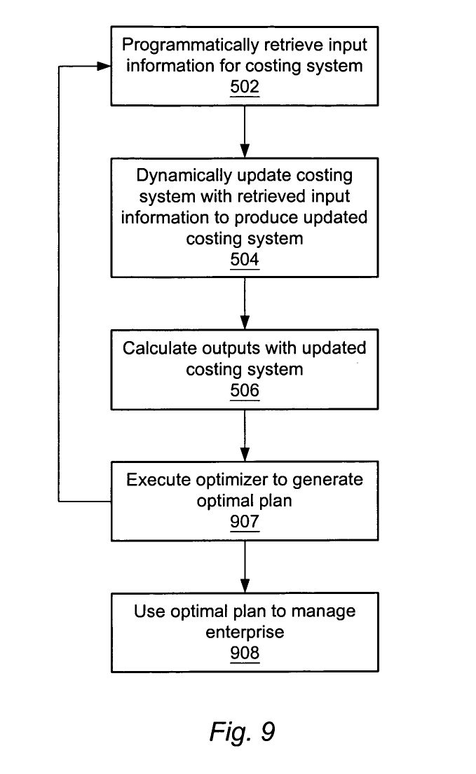

FIG. 9—Method of Using a Dynamic Cost Accounting System with an Optimizer

FIG. 9 flowcharts one embodiment of a method of using a dynamic cost accounting system with an optimizer to calculate outputs useful in managing an enterprise. It is noted that in various embodiments, some of the steps shown may be performed in a different order than shown, or may be omitted. Additional steps may also be performed.

As FIG. 9 shows, in 502, the costing system 220 of the enterprise 208 may programmatically retrieve input information 210 from one or more information sources 206, as described above.

Then, in 504, the costing system 220 may be dynamically updated with the retrieved input information 210, thereby producing an updated costing system, as described in detail above with reference to FIG. 5.

In 506, the updated costing system may calculate one or more outputs comprising updated costing information related to operations of the enterprise 208, as also described above with reference to FIG. 5. The one or more outputs may be provided to an optimizer, as shown in FIG. 8, described above.

In 907, the optimizer may be executed using the one or more calculated outputs to generate an optimal (or substantially optimal) plan. In other words, the optimizer may be executed to produce a result set (plan) particular to the one or more outputs provided by the updated costing system, as described above with reference to FIG. 8.

As FIG. 9 also shows, in one embodiment, each time the dynamic cost accounting system is updated, producing updated cost information as output, the optimizer may be executed again to generate an updated optimal plan. In one embodiment, the optimizer may be executed automatically each time the costing system is updated, and update costing outputs calculated.

Finally, in 908, the generated optimal plan may be used to manage the enterprise. Thus, as conditions and resources change over time, and the costing system is updated to reflect those changes, the optimizer may be executed automatically to generate corresponding optimal plans for use in managing the enterprise.

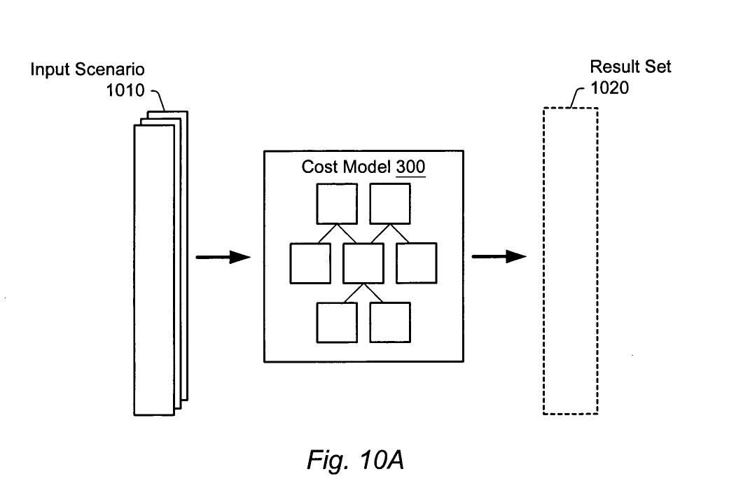

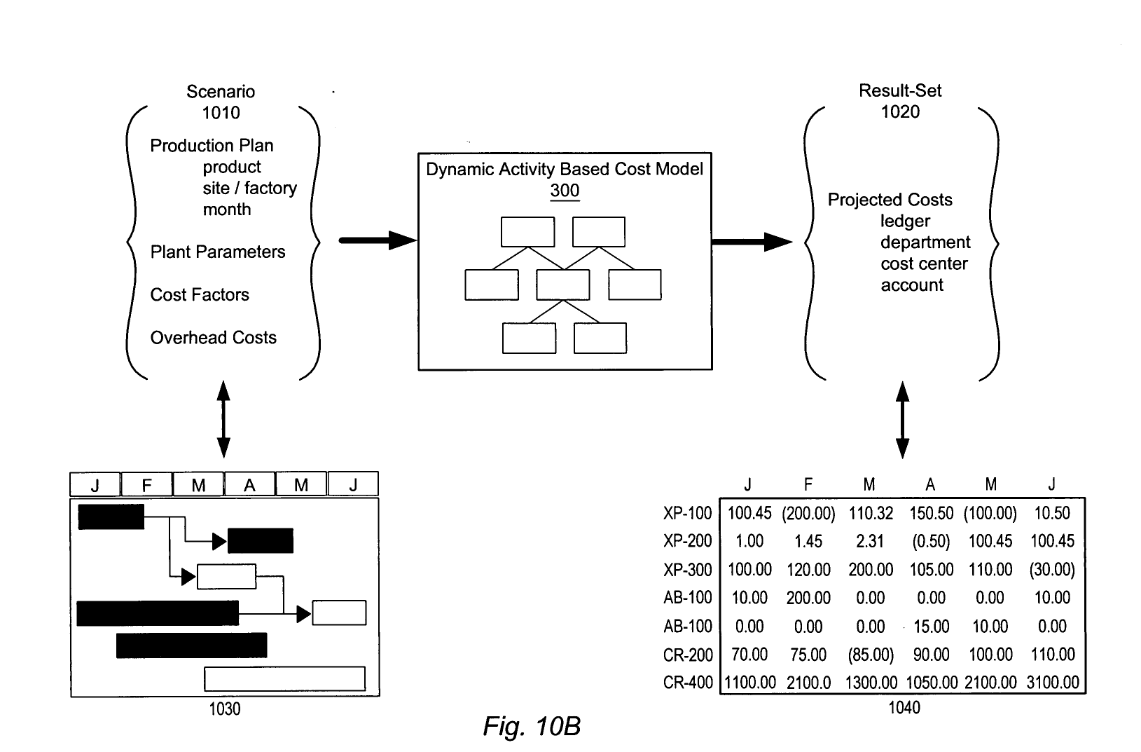

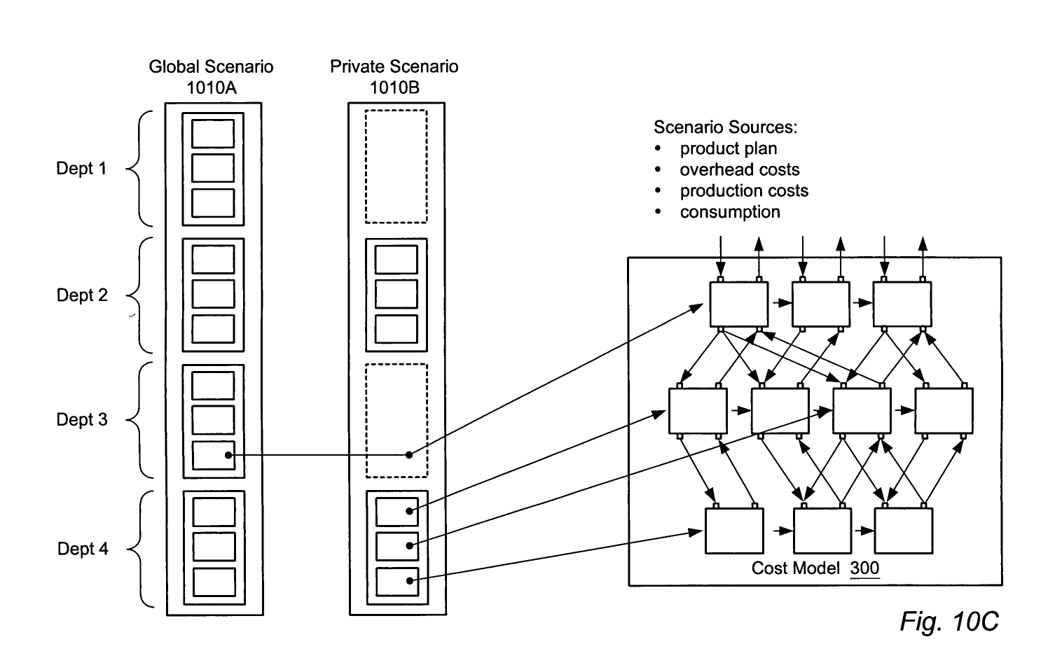

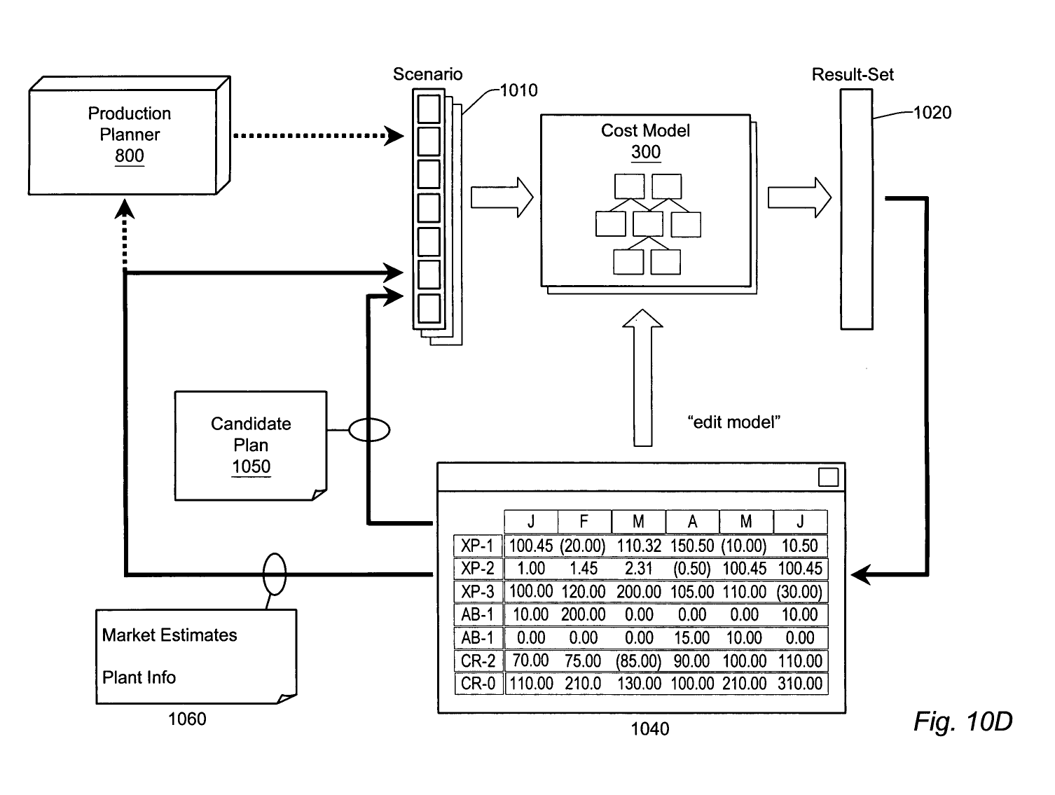

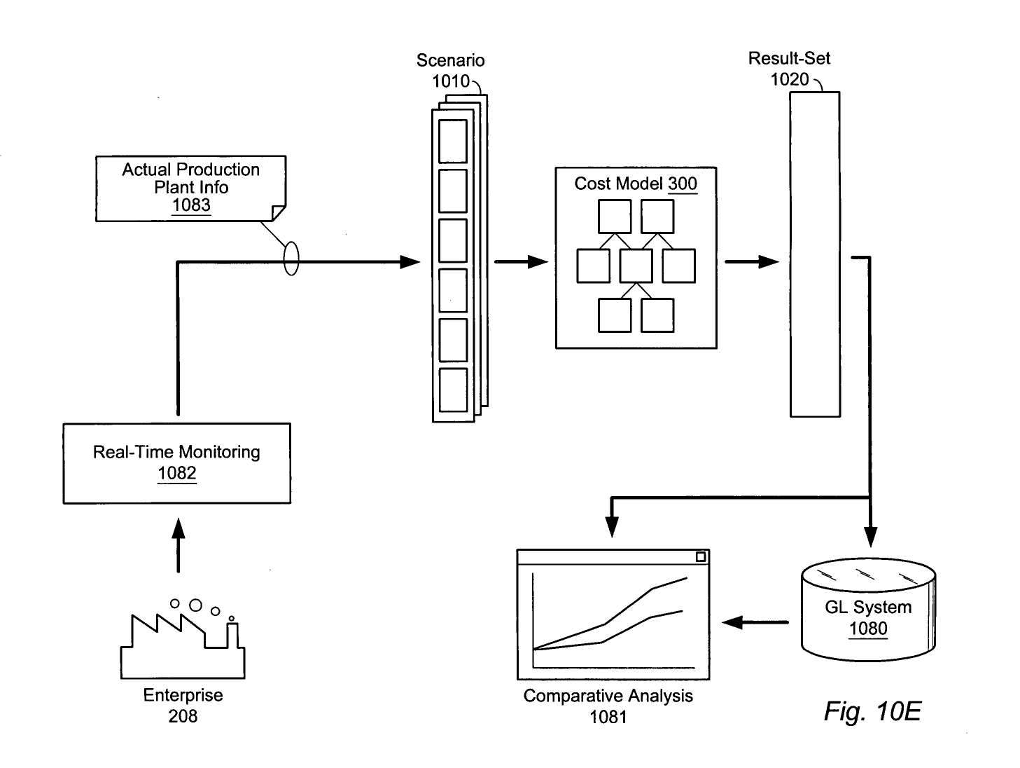

FIGS. 10A Through 10E—Scenario Planning

By linking the dynamic cost accounting system of an enterprise to one or more business systems of the enterprise, the dynamic cost information provided by the cost accounting system may be used to improve strategic and tactical planning processes and systems. FIG. 10A illustrates how a dynamic cost accounting system may be used in strategic or tactical planning for an enterprise by producing result sets 1020 for a scenario 1010 or set of scenarios. A cost model 300 may receive information specifying one or more scenarios 1010. The cost model 300 may execute using the received scenario information 1010, and may generate a result set 1020, e.g., a set of estimated financial metrics, corresponding to the scenario 1010 or set of scenarios.

FIG. 10B illustrates a more detailed embodiment of the process of FIG. 10A. In one embodiment, the scenario information 1010 may specify a proposed production plan, as well as conditions associated with the proposed plan, such as plant parameters, cost factors and overhead costs. A graphical example of the proposed production plan 1030 illustrates a production plan with a six month horizon. In one embodiment, the result set generated for each scenario or set of scenarios may include projected cost information. The projected costs may be allocated among various account categories, such as, for example, general ledger accounts, enterprise departments, cost centers, and enterprise accounts. A graphical example of the allocation of projected costs 1040 corresponding to the six-month production plan 1030 is shown in tabular form, where each row corresponds to an account category, and each column corresponds to a month in the production plan. In one embodiment, each row corresponds to a unique combination of account categories.

FIG. 10C illustrates possible embodiments of scenarios 1010 used by the present invention. As FIG. 10C shows, in one embodiment, a global scenario 1010A may be provided which includes a default set of scenario information which may be accessed by various users in the enterprise, preferably in a read-only fashion. In one embodiment, a user may generate a private scenario 1010B based on the global scenario, which is particular to the user's needs. The user may over-ride all or a portion of the scenario information provided in the global scenario 1010A. Those portions not over-ridden may default to the corresponding values of the global scenario 1010A. Thus, various users may modify the information provided by the global scenario, thereby generating private or local scenarios 1010B which fit each user's particular requirements.

In one embodiment, the information in a scenario 1010 may be organized in various ways as desired by individual users to facilitate navigation of the information from different views. As FIG. 10C shows, the particular organization of the information in a scenario 1010 has no bearing on the use of the scenario information by the cost model 300. In other words, the cost model 300 utilizes the various portions of the scenario 1010 correctly, irrespective of the particular organization of the information in the scenario 1010.

FIG. 10D illustrates the manner in which a dynamic cost accounting system may be used to generate and evaluate different planning scenarios 1010 for the production of goods or services. In the embodiment shown, a scenario 1010 has been generated which may comprise a production plan and information about the enterprise including plant-production information and external market conditions, as described above with reference to FIG. 10B. In various embodiments, the production plan included in the scenario may be either a candidate plan 1050 specified directly by a user, or generated by a production planner 800, for example, based on market estimates and plant information 1060. The cost model 300 may be used to compute result set 1020, i.e., the projected costs described above with reference to FIG. 10B. The projected costs may then be analyzed, for example, by a user, in conjunction with the scenario 1010 to evaluate the appropriateness of the candidate plan 1050. In other words, the projected cost information 1020 may be presented in a form 1040 accessible to the user for analysis. The candidate plan 1050, the enterprise information, and/or the cost model may then be altered and the process repeated as desired.

FIG. 10E illustrates the manner in which a dynamic cost accounting system may be used to generate real-time performance monitoring information. In contrast with the process illustrated in FIG. 10D, this process can be performed as an automated background process. A real-time monitoring system 1082 is used to gather information about the actual production and business context in the enterprise 1008. This real-time information is integrated into a scenario 1010 and used to compute a resulting set of costs 1020. This real-time prediction of cost is fed into a tool 1081 for viewing and analysis. In addition, the tool can receive budgeted cost information from the general ledger 1080 in order to generate any of a number of comparative analysis reports.

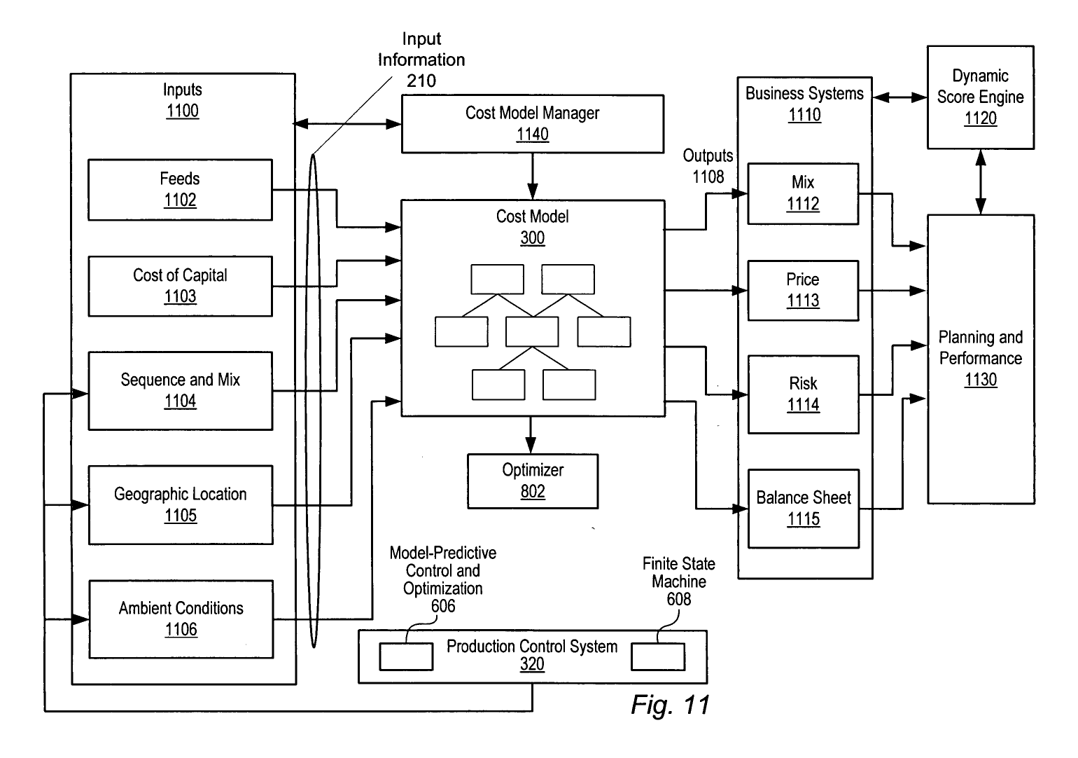

FIG. 11—Dynamic Cost Accounting System Linked With Operation System and Business System

FIG. 11 illustrates how cost models in accordance with the present invention can be linked with one or more operations systems of an enterprise and with one or more business systems of the enterprise, according to one embodiment. By linking with one or more operations systems, the dynamic cost accounting system may receive as input information 210 demand-side information. By linking with one or more business systems, the dynamic cost accounting system may provide dynamic cost and resource information that reflects changes in the demand-side information received from the operations systems. Thus, a dynamic cost accounting system may better link financial measurement with operations systems of the enterprise, such as, for example, the physical and workflow management systems of the enterprise.

As shown in FIG. 11, the cost model 300 may receive updated information from sources internal and/or external to the enterprise, and provide updated outputs 1108 corresponding to the updated information to processes within the enterprise. In this embodiment, the activity cost model receives input information 210 from a number of inputs 1100, some providing information from sources external to the enterprise, others providing information from sources internal to the enterprise. In one embodiment, inputs such as feeds 1102 (e.g., price of gasoline) and cost of capital (1103) may be provided from databases maintained by third parties and available through the Internet and that may be capable of providing current resource costs. Inputs such as the sequence and mix specifications of products being produced 1104, the geographic location of the plant in which a product is produced 1105, and ambient conditions 1106 of the production process may be derived from one or more sources internal to the enterprise, such as the production control system 320 shown in FIG. 6, or an enterprise requirements planning system, supply chain management systems, or any other enterprise system that provides information relating to state costs. Other examples of inputs to the cost model 300 include cost of resources, cost of capital, customer information, environment information and executive instructions, among others. One or more of the inputs 1100 may change over time. The dynamic cost accounting system may be able to programmatically retrieve the input information 210 received from one or more of the inputs 1100 and update the cost model 300 in accordance with the retrieved input information 210. This approach may provide a scalable and efficient mechanism to use real-time information to accurately ascertain operating costs. As quickly as the external and internal systems can communicate significant changes, the cost model may regenerate estimated costs taking into account local conditions and changes in resource values. Dynamic cost accounting may provide the means to determine costs by using information from one or more external information sources and enterprise systems to dynamically set the value of the parameters of the cost model.

The embodiment shown in FIG. 11 shows a cost model manager 1140 that monitors the cost inputs 1100 received from one or more information sources 206 and manages the process of updating the costing system with changes in the retrieved input information 210. The cost model manager 1140 may perform this management function by retrieving the input information 210 if a change in the input information exceeds a threshold, and updating the cost model 300 with the retrieved input information. In another embodiment, the cost model manager may retrieve an element of the input information 210 if a change in the element of the input information exceeds a threshold, and update the cost model 300 by dynamically updating the cost model in accordance with the retrieved element.

This increased visibility and understanding of costs can then be leveraged in many work processes and systems. As shown in FIG. 11, the dynamically updated costs may be provided by the cost model 300 to one or more enterprise processes 1110. These enterprise processes may include, for example, product mix optimization 1112, pricing systems 1113, risk management applications 1114, and financial analysis 1115. Other enterprise processes that may receive updated costs from the cost model include, for example, systems used for strategic planning, product mix optimization, scheduling applications, process optimization, unit optimization, budgeting applications, trading applications, and performance management, among others.

Planning systems can benefit by understanding the significant dynamics in capacity associated with the individual production units. Environmental conditions, feedstock variations, and other factors may change the realizable total output from the process. There are many production processes that have significant dynamics in their cost drivers. The approach described herein may use enhanced modeling techniques to add dynamics to the traditional ABC cost methodology. The traditional cost-driver and resource-driver constants in the ABC model may be replaced with functions. These functions may be implemented as models of the salient characteristics of the production processes. These models may provide the information on how variations in cost can occur as a function of how the plant or enterprise is operated.

In production scheduling applications, the mix of products and their respective output volumes, along with ambient conditions and other factors, create dynamics in the value of COGS. By including key status information such as current total output etc, dynamic cost accounting systems may provide a more accurate estimate of COGS for any given situation. The cost model used to provide the driver dynamics may be determined by a series of state conditions for the process. Using signals from the production process, the system may modify driver values in the cost model and/or switch cost driver models in and out of a cost model network. Total COGS estimates may be generated by running all of the models in the network and aggregating the results.

In trading applications, the use of dynamic cost information may help companies understand the margins at the order level. Using the cost models as described herein, companies may have the critical supply-side information needed to set the price on each order appropriately. Thus, the approaches described herein may have value to any organization that buys, sells or trades in dynamic and volatile markets. Dynamic cost accounting may provide customer-facing systems with the ability to determine the zero-margin point on an ad hoc basis.

Armed with dynamically updated costs from the cost model 300, the enterprise processes 1110 may provide more accurate cost information to enterprise planning and performance management applications 1130. Performance management applications are intended to provide companies with visibility in how the organization is performing to expectations and to plans. In this context the process model may be used to estimate the driver values for any set of circumstances. The driver values may then be set in the cost model for cost calculation. As the production control system senses and responds to disturbances, the cost model driver values may be automatically modified to insure the cost model is kept up-to-date. The cost models may be used in dynamic score engines 1120 to generate performance indicators useful in enterprise planning and performance management applications 1130. Examples of dynamic score engines are applications that generate Key Performance Indicators (KPI's) for the enterprise. KPIs so derived may then better reflect the true and unique financial performance of the processes.

Although the system and method of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

1. A computer-implemented method for performing dynamic cost accounting for an enterprise, wherein the enterprise comprises a costing system, the method comprising:
programmatically retrieving input information for the costing system, wherein the costing system comprises one or more cost models, and wherein the input information comprises a series of state conditions of the process, comprising one or more of:
historical process conditions;
current process conditions; and
projected process conditions; and
the costing system executing the one or more cost models using the series of state conditions, thereby calculating one or more cost outputs, wherein the one or more cost outputs are usable in managing the enterprise.

2. The method of claim 1, wherein said programmatically retrieving input information comprises programmatically retrieving input information from one or more information sources over a network.

3. The method of claim 2, wherein at least one of said one or more information sources are remote from the costing system.

4. The method claim 1,
wherein each of said one or more cost models comprises one or more cost pools.

5. The method claim 1,
wherein each of said one or more cost models comprises two or more cost pools, and wherein the two or more cost pools are connected by linkages.

6. The method claim 1, wherein each of said one or more cost models comprises one or more parameters.

7. The method of claim 6, wherein said one or more parameters comprises a numerical value.

8. The method of claim 6, wherein said one or more parameters comprises a model.

9. The method of claim 6, wherein each of said one or more cost models comprises one or more consumption propagation models.

10. The method of claim 1, wherein said input information comprise one or more of:
cost of resources;
cost of capital;
sequence and mix specifications;
geographic location;
ambient conditions;
customer information;
environmental information; and
executive instructions.

11. The method of claim 1,
wherein the enterprise further includes a production model; and
wherein said input information comprise one or more parameters of the production model.

12. The method of claim 1,
wherein the enterprise further includes a production process; and
wherein said input information comprise one or more parameters of the production process.

13. The method of claim 1, wherein said programmatically retrieving input information comprises:
monitoring input information from one or more information sources; and
if a value or change in value in an element of the input information matches one or more criteria, retrieving said element.

14. The method of claim 1,
wherein the enterprise further includes a prediction model;
wherein said input information comprise one or more outputs of the prediction model; and
wherein the costing system is operable to calculate predictive costing information for the enterprise based on the one or more outputs of the prediction model.

15. The method of claim 1,
wherein the input information are time-dependent;
wherein said programmatically retrieving input information for the costing system comprises programmatically retrieving historical input information; and
wherein the one or more outputs are usable in analyzing operational tactics and/or strategies for the enterprise.

16. The method of claim 1,
wherein the input information comprises substantially real-time input information; and
wherein the one or more outputs indicate how costs vary as a function of resource consumption in the context of current operating conditions of the enterprise.

17. The method of claim 1,
wherein the input information are synthesized input information;
wherein said programmatically retrieving input information for the costing system comprises programmatically retrieving the synthesized input information; and
wherein the one or more outputs are usable in analyzing hypothetical scenarios for the enterprise.

18. The method of claim 1, wherein the enterprise further comprises one or more optimizers, the method further comprising:
the one or more optimizers operating in conjunction with the costing system to evaluate a plurality of plans, wherein the costing system operates to provide one or more estimated financial metrics for each of the plurality of plans;
the one or more optimizers selecting an optimal plan of said plurality of plans based on one or more constraints and objectives; and
outputting the optimal plan, wherein the optimal plan indicates optimal operations for the enterprise.

19. The method of claim 1,
wherein the input information comprise substantially real-time input information indicating substantially current operating conditions for the enterprise; and
wherein the one or more outputs indicate substantially current costs for the enterprise;
the method further comprising:
computing a performance metric for the enterprise based on the one or more outputs of the updated costing system, wherein the performance metric provides a measure of efficiency for the enterprise.

20. The method of claim 19, wherein the performance metric comprises a key performance indicator for the enterprise, and wherein the key performance indicator indicates financial performance of the enterprise.

21. The method of claim 1,
wherein the enterprise further includes a business process; and
wherein said input information comprise one or more parameters of the business process.

22. The method of claim 1,
wherein said calculating said one or more outputs comprises calculating costs over one or more general ledger code accounts.

23. The method of claim 1, further comprising:
dynamically updating the costing system in accordance with the retrieved input information to generate an updated costing system, wherein said costing system executing the one or more cost models using the series of state conditions comprises:
the updated costing system calculating the one or more outputs.

24. The method of claim 23, wherein said updating is performed at least monthly.

25. The method of claim 23, wherein said updating is performed at least weekly.

26. The method of claim 23, wherein said updating is performed at least daily.

27. The method of claim 23, wherein said updating is performed at least hourly.

28. The method of claim 23, wherein said updating is performed at least once per minute.

29. The method of claim 23, wherein said updating is performed at least once per second.

30. The method of claim 23, wherein said updating is performed at least once per millisecond.

31. The method of claim 23,
wherein said programmatically retrieving input information comprises:
monitoring input information from one or more information sources; and
if a value or change in value in an element of the input information matches one or more criteria, retrieving said element; and
wherein said dynamically updating the costing system in accordance with the retrieved input information comprises:
dynamically updating the costing system in accordance with the retrieved element.

32. The method of claim 23, wherein said input information comprise one or more of:
cost of resources;
cost of capital;
sequence and mix specifications;
geographic location;
ambient conditions;
customer information;
environmental information; and
executive instructions.

33. The method of claim 23,
wherein said updating comprises aggregating at least a subset of said plurality of cost models into a single model.

34. The method claim 23,
wherein each of said one or more cost models comprises one or more cost pools; and
wherein said updating the costing system comprises modifying at least one of said one or more cost pools based on the retrieved input data.

35. The method claim 23,
wherein each of said one or more cost models comprises two or more cost pools, and wherein the two or more cost pools are connected by linkages; and
wherein said updating the costing system comprises modifying at least one of said one or more linkages based on the retrieved input data.

36. The method claim 23,
wherein each of said one or more cost models comprises one or more parameters; and
wherein said updating the costing system comprises modifying at least one of said one or more parameters based on the retrieved input information.

37. The method of claim 36, wherein said one or more parameters comprises a numerical value.

38. The method of claim 36, wherein said one or more parameters comprises a model.

39. The method of claim 36,
wherein each cost model comprises one or more consumption propagation models; and
wherein said updating comprises modifying one or more coefficients of at least one of said one or more consumption propagation models.

40. The method of claim 36,
wherein each cost model comprises one or more consumption propagation models; and
wherein said updating comprises replacing at least one of said one or more consumption propagation models with a different consumption propagation model.

41. The method of claim 36,
wherein each cost model comprises one or more consumption propagation models; and
wherein said updating comprises adding a new consumption propagation model to said one or more consumption propagation models.

42. The method of claim 23,
wherein said programmatically retrieving input information comprises:
monitoring input information from one or more information sources; and
if a value or change in value in an element of the input information matches one or more criteria, retrieving said element; and
wherein said dynamically updating the costing system in accordance with the retrieved input information comprises:
dynamically updating the costing system in accordance with the retrieved element.

43. The method of claim 23,
wherein the enterprise further comprises one or more optimizers;
wherein said programmatically retrieving input information comprises:
monitoring input information from one or more information sources; and
if a change in an element of the input information exceeds a threshold, retrieving said element; and
wherein said dynamically updating the costing system in accordance with the retrieved input information comprises:
dynamically updating the costing system in accordance with the retrieved element;
the method further comprising:
providing the one or more outputs of the updated costing system to the one or more optimizers;
providing one or more objectives and constraints to the one or more optimizers; and
executing the one or more optimizers in response to said programmatically retrieving and said dynamically updating to determine one or more optimal operating parameters for the enterprise in accordance with the one or more objectives and constraints.

44. The method of claim 43, further comprising:
implementing the determined one or more optimal operating parameters in the enterprise.

45. The method of claim 23,
wherein the input information for the costing system comprises state information regarding a system or process;
wherein said dynamically updating the costing system comprises updating a state model of the system or process; and
wherein said calculating one or more outputs comprises calculating one or more state costs related to the system or process.

46. A carrier medium which stores program instructions for performing dynamic cost accounting for an enterprise, wherein the enterprise comprises a costing system, and wherein the program instructions are executable by a processor to perform:
programmatically retrieving input information for the costing system, wherein the costing system comprises one or more cost models, and wherein the input information comprises a series of state conditions of the process, comprising one or more of:
historical process conditions;
current process conditions; and
projected process conditions; and
the costing system executing the one or more cost models using the series of state conditions, thereby calculating one or more cost outputs, wherein the one or more cost outputs are usable in managing the enterprise.

47. The carrier medium of claim 46, wherein said programmatically retrieving input information comprises programmatically retrieving input information from one or more information sources over a network.

48. The carrier medium of claim 47, wherein at least one of said one or more information sources are remote from the costing system.

49. The carrier medium of claim 46, wherein the program instructions further implement one or more optimizers, wherein the one or more optimizers are executable by the processor to perform:
operating in conjunction with the costing system to evaluate a plurality of plans, wherein the costing system operates to provide one or more estimated financial metrics for each of the plurality of plans;
selecting an optimal plan of said plurality of plans based on one or more constraints and objectives; and
outputting the optimal plan, wherein the optimal plan indicates optimal operations for the enterprise.

50. The carrier medium of claim 49, wherein the program instructions are further executable by the processor to perform:
implementing the optimal plan in the enterprise.
wherein said programmatically retrieving input information comprises:
monitoring input information from one or more information sources; and
if a change in an element of the input information exceeds a threshold, retrieving said element.

51. The carrier medium of claim 46, wherein the program instructions are further executable by a processor to perform:
dynamically updating the costing system in accordance with the retrieved input information to generate an updated costing system, wherein said costing system executing the one or more cost models using the series of state conditions comprises the updated costing system calculating the one or more outputs

52. The carrier medium of claim 51, wherein said updating is performed more than once per year.

53. The carrier medium of claim 51, wherein said updating is performed one of:
at least monthly, at least weekly, at least daily, at least hourly, at least once per minute, at least once per second, at least once per millisecond.

54. The carrier medium of claim 51, wherein the program instructions further implement one or more optimizers, wherein the one or more optimizers are executable by the processor to perform:
operating in conjunction with the costing system to evaluate a plurality of plans, wherein the costing system operates to provide one or more estimated financial metrics for each of the plurality of plans;
selecting an optimal plan of said plurality of plans based on one or more constraints and objectives; and
outputting the optimal plan, wherein the optimal plan indicates optimal operations for the enterprise.

55. The carrier medium of claim 51, wherein the program instructions are further executable by the processor to perform:
implementing the optimal plan in the enterprise.
wherein said programmatically retrieving input information comprises:
monitoring input information from one or more information sources; and
if a change in an element of the input information exceeds a threshold, retrieving said element; and
wherein said dynamically updating the costing system in accordance with the retrieved input information comprises:
dynamically updating the costing system in accordance with the retrieved element.

56. A system for performing dynamic cost accounting for an enterprise, wherein the enterprise comprises a costing system, the system comprising:
a computer system, comprising:
a memory which stores program instructions implementing a dynamic cost accounting system; and
a processor coupled to said memory;
wherein said program instructions are executable by said processor to:
programmatically retrieve input information for the costing system, wherein the costing system comprises one or more cost models, and wherein the input information comprises a series of state conditions of the process, comprising one or more of:
historical process conditions;
current process conditions; and
projected process conditions; and
wherein the costing system is operable to:
execute the one or more cost models using the series of state conditions, thereby calculating one or more cost outputs, wherein the one or more cost outputs are usable in managing the enterprise.

57. The system of claim 56, further comprising:
one or more information sources coupled to the computer system over a network;
wherein said programmatically retrieving input information comprises programmatically retrieving input information from the one or more information sources.

58. The system of claim 56, wherein at least one of said one or more information sources are remote from the costing system.

59. The system of claim 56, wherein said updating is performed more than once per year.

60. The system of claim 56, wherein said program instructions are executable by said processor to:
dynamically update the costing system in accordance with the retrieved input information to generate an updated costing system; and
wherein the updated costing system is operable to calculate the output information, wherein the output information is usable in managing the enterprise.

61. A system for performing dynamic cost accounting for an enterprise, wherein the enterprise comprises a costing system, the system comprising:
means for programmatically retrieving input information for the costing system, wherein the costing system comprises one or more cost models, and wherein the input information comprises a series of state conditions of the process, comprising one or more of:
historical process conditions;
current process conditions; and
projected process conditions; and
means for the costing system executing the one or more cost models using the series of state conditions, thereby calculating one or more cost outputs, wherein the one or more cost outputs are usable in managing the enterprise.

62. The system of claim 61, further comprising:
means for dynamically updating the costing system in accordance with the retrieved input information to generate an updated costing system; and
means for the updated costing system calculating the one or more outputs.
